(19) United States
(12) Patent Application Publication
(10) Pub. No.: US 2025/0210683 A1
(43) Pub. Date: Jun. 26, 2025

(54) FUEL CELL ASSEMBLY COMPRISING A SUPPORT STRUCTURE ARRANGED TRANSVERSELY TO THE STACKING DIRECTION

(71) Applicant: Aerostack GmbH, Dettingen an der Erms (DE)

(72) Inventors: Manuel Morcos, Dettingen an der Erms (DE); Christian Becker, Dettingen an der Erms (DE)

(21) Appl. No.: 18/849,857

(22) PCT Filed: Mar. 2, 2023
(86) PCT No.: PCT/EP2023/055291

§ 371 Date: Sep. 23, 2024

(30) Foreign Application Priority Data
Mar. 24, 2022 (DE) 10 2022 107 037.9

(51) Int. Cl. H01M 8/2475; H01M 8/248

(52) U.S. Cl. CPC H01M 8/2475; H01M 8/248; H01M 2250/20

(57) ABSTRACT

A fuel cell stack has an arrangement of fuel cells stacked in a stack direction, two end plates which delimit the arrangement and are arranged opposite one another in the stack direction, and a supporting structure which runs on at least one side surface of the arrangement and at least between the end plates, the supporting structure configured to support the fuel cells transversely with respect to the stack direction, to counteract slipping of the fuel cells transversely with respect to the stack direction. The supporting structure has an element which is preshaped such that, in a mounted state, the supporting structure exerts a prestress which acts on the arrangement of fuel cells, and the prestress acts on the arrangement of fuel cells transversely with respect to the stack direction.

### TECHNICAL FIELD

The present disclosure relates to a supporting structure for fuel cell arrangements.

### TECHNICAL BACKGROUND

In view of increasing environmental protection efforts, hydrogen is increasingly gaining in importance as an energy source. Here, the energy stored in the hydrogen can be converted, for example, in fuel cells into electrical energy. Different requirements are made of fuel cells, in particular in aerospace applications, but also in other highly dynamic environments.

In a fuel cell stack, a plurality of fuel cells or fuel cell components such as, for example, bipolar plates are usually pressed together between two end plates by way of a defined pressure load. If, however, vibrations occur, these vibrations together with gravity or other actions of force such as, for example, as a result of centrifugal forces can lead to relative movements of the individual cells of the fuel cell stack with respect to one another. In the case of a horizontal position of the fuel cell stack in particular, this can lead to a “deflection” of the entire fuel cell stack. Corresponding displacements can also occur, however, in the case of a vertical orientation of the fuel cell stack. In particular, the highly challenging shock and vibration conditions in aerospace can lead to a pronounced deflection of the fuel cell stack and therefore to possible damage.

Lateral supporting structures are known, in the case of which a strap runs around the fuel cell stack. On account of the flexural slackness of the strap, however, structures of this type cannot reliably prevent a relative displacement of the components of the fuel cell stack with respect to one another, in particular in the case of high loads.

Accordingly, it is an object of the invention to provide a supporting structure for a fuel cell stack, which supporting structure effectively prevents lateral displacement of individual cells with respect to one another or a deflection of the entire stack.

This object is achieved by way of the subjects of the independent patent claims. Further embodiments result from the dependent claims and from the following description.

In the present case, a fuel cell stack with a supporting structure which prevents lateral slipping of the fuel cells and a method for mounting a supporting structure of this type are disclosed. Features which are described with regard to the fuel cell stack also apply to the method and vice versa.

In accordance with a first aspect, a fuel cell stack is disclosed. The fuel cell stack comprises an arrangement of a plurality of fuel cells which are stacked in a stack direction, two end plates which delimit the arrangement and are arranged opposite one another in the stack direction, and a supporting structure which runs on at least one side surface of the arrangement and at least between the end plates. The supporting structure is configured to support the fuel cells transversely with respect to the stack direction, in order to counteract a deformation of the arrangement of a plurality of fuel cells. The supporting structure has an element which is preshaped in such a way that, in a mounted state, the supporting structure exerts a prestress which acts on the arrangement of a plurality of fuel cells. The prestress acts on the arrangement of a plurality of fuel cells transversely with respect to the stack direction.

A deformation of the arrangement of a plurality of fuel cells can be, for example, slipping of the fuel cells transversely with respect to the stack direction, but also any other deformation. The supporting structure, as described herein, effectively prevents a deformation of this type.

Each of the fuel cells comprises corresponding components, that is to say, for example, bipolar plates, electrolyte layers, sealing layers, gas diffusion layers, membrane layers and catalyst layers, as is known to a person skilled in the art. Here, a plurality of fuel cells of this type are in turn stacked on one another in such a way that the individual fuel cells result in a stacked arrangement of fuel cells, which arrangement is held together overall between two end plates. Here, the individual fuel cells form a homogeneous column with uniform lateral surfaces, that is to say the column forms substantially planar lateral surfaces in an unloaded state of the fuel cell stack.

Although the end plates already provide a basic tension, running in the stack direction, in the fuel cell stack, both displacements of the individual fuel cells with respect to one another can occur in the effect of forces acting transversely with respect to the stack direction, and a deformation of the entire stack as a composite can also occur. In the first case, a multiplicity of micro-movements can occur which can likewise lead to a global deformation of the stack. It can be assumed that both phenomena occur at the same time. Micro-movements are more likely to occur when dynamic mechanical influences such as, for example, vibrations occur in addition to the abovementioned static forces.

In order to prevent deflections of this type, the present disclosure provides a lateral supporting structure. Here, the supporting structure is a mechanical element for reducing or avoiding the deformation of the fuel cell stack, and acts laterally on the arrangement of the fuel cells, with the result that a support load is applied to the fuel cell stack or its components. The supporting structure supports the fuel cell stack or the arrangement of the fuel cells at least in a direction transversely or perpendicularly with respect to the stack direction, by it preventing a movement of the fuel cells relative to one another along this supporting direction by way of an applied prestress which acts against the arrangement of fuel cells and/or on one or more lateral surfaces of the arrangement of fuel cells.

The supporting structure uses at least one preshaped element which presses against the arrangement of fuel cells at least in a direction transversely or perpendicularly with respect to the stack direction, or counteracts a displacement of the arrangement of a plurality of fuel cells in at least one direction transversely or perpendicularly with respect to the stack direction.

For example, the preshaped element can be a resilient element, the spring force of which presses correspondingly against the arrangement of fuel cells. In a refinement of this type, the supporting structure preferably runs at least on opposite sides of the fuel cell stack and presses via the preshaped element onto the side surfaces of the corresponding sides in such a way that the arrangement of the fuel cells or the individual fuel cells is/are prevented from slipping in the corresponding connecting direction between the two side surfaces. As a result of the use of a two-sided supporting structure of this type with preshaped elements as resilient elements (which induce stress transversely or perpendicularly with respect to the arrangement), it can be prevented that individual fuel cells are pressed out of the arrangement by way of the resilient elements themselves.

In addition, the supporting structure together with components of the arrangement of fuel cells, for example with the bipolar plates, but also other stack components, can be shaped in such a way that a displacement in both directions perpendicularly with respect to the stack direction is likewise prevented. For example, as described further below, this is achieved by way of chamfered contact surfaces. In this way, by way of a single supporting structure which is mounted along an axis and which is intended to prevent or reduce the deformation of the fuel cell stack in the direction of this axis, it is possible at the same time to prevent/reduce the second axis and therefore the movement/deformation of the stack in that the second axis. The supporting structure and the stack components which are in engagement can be shaped to this end, for example, in such a way that they are in chamfered contact with one another, as will be described in greater detail further below.

In general, the supporting structure (or the preshaped element of the supporting structure) runs at least between the end plates or an element of a bracing unit which fixes the fuel cell stack. A bracing unit does not necessarily consist exclusively of an end plate, but rather can be constructed from a multiplicity of components. Here, for example, the supporting structure can be fastened to one of these bracing elements of the bracing unit itself, for example by way of welding, screwing, riveting, adhesive bonding, or any other suitable fastening type. The supporting structure can also, however, be fastened in an identical way to a surrounding structure (for example, a base plate, on which the fuel cell stack is attached).

The preshaped element can also be a rigid element which runs laterally at least between the end plates of the fuel cell stack. For example, the supporting structure can be a structural component such as, for example, a rod or a bar which runs laterally on at least one of the side surfaces of the fuel cell stack substantially in the stack direction or extends in the stack direction and is correspondingly shaped, in order to support the arrangement laterally.

In general, the supporting structure can also comprise an electrically insulating component or layer which lies in between, and can thus be insulated from the arrangement of a plurality of fuel cells, with the result that a direct contact of electrically conductive or mechanically rigid constituent parts of the supporting structure, such as the preshaped element, with the components of the individual fuel cells is avoided, as a result of which the risk of short-circuits by way of a plurality of fuel cells being bridged and the risk of mechanical damage are reduced. In addition, a layer of this type can be configured as a sliding element, or an additional sliding element can be provided which can slide along the stack direction with respect to the supporting structure or with respect to the preshaped element. A sliding element of this type is therefore fixed along the stack direction on the supporting structure or on the side surface, and can slide on the other side. As a result, damage of the plurality of fuel cells as a result of an undesired action of force along the stack direction on the fuel cells or their components is avoided.

In addition, in interaction with the bracing elements which are already required for the stack bracing such as, for example, straps, tie rods, etc., the supporting structure can be provided between the preshaped element of the supporting structure and the arrangement of a plurality of fuel cells. In this way, it is possible, with the aid of the already existing mechanical components of the bracing system, for the supporting structure to be pressed onto the fuel cell components and therefore for improved pressing onto the stack to be realized. In addition, in the case of a suitable structural embodiment, those contact partners can be used as sliding elements, in order thus to compensate for potential relative movements in the stack direction.

In addition, as is described further below, a compressible component and/or a protective layer and/or a sacrificial material (a material which may be damaged, that is to say cut into by way of the cell components, to a certain extent by way of the fuel cells, as a result of which a common contact area is provided between the cell components and the supporting structure) can be provided between the side surface of the arrangement of a plurality of fuel cells and the remaining components of the supporting structure. A component of this type can be adapted to the contour of the corresponding side surface and can thus likewise prevent damage as a result of the action of force along the stack direction. A non-uniform surface caused by way of the offset of individual cell components with respect to one another can lead to a non-homogeneous action of force, which can result in the damage of the cell components. For this reason, a structural solution described herein for reducing force peaks and/or for balancing the surface pressure is optionally envisaged.

In addition, the supporting structure can also be provided and arranged on each of the side surfaces of the fuel cell stack as a single contiguous component or as a multiple-part component, the individual components of the supporting structure running substantially parallel to one another along the stack direction. In addition, the supporting structure can act either completely and over the full surface area, on each side surface on which it is present, along the entire stack direction on the arrangement of a plurality of fuel cells, or can act merely in a punctiform manner along the stack direction on the arrangement. In the case of the use of a resilient element, the latter can be configured, for example, on each side surface as a type of clip which, in an installed state, acts in a central region of the corresponding side surface in relation to the stack direction. Moreover, it is conceivable that the prestress varies along the stack direction. For instance, a lower prestress can be necessary, for example, at locations of the arrangement of a plurality of fuel cells which are close to the end plates than at central locations centrally between the end plates.

The prestress of the supporting structure on each side surface of the fuel cell stack, to which side surface a supporting structure of this type is attached, can act here on the respective side surface perpendicularly or parallel or both perpendicularly and parallel (for example, in the abovementioned embodiment with chamfered contact surfaces) with respect to the corresponding side surface on the arrangement of a plurality of fuel cells, and can thus provide a supporting effect merely in one side direction of the arrangement or in both side directions of the arrangement.

In accordance with one embodiment, the supporting structure runs on at least one pair of two side surfaces of the fuel cell stack which are opposite one another.

A lateral displacement (partial or complete) of the arrangement of a plurality of fuel cells by way of the supporting structure itself is avoided as a result of the two-sided arrangement on opposite sides, which displacement might occur, for example, if a force acts merely on one side surface perpendicularly on the side surface, which force is not compensated for by way of a counterforce on the opposite side.

In accordance with a further embodiment, the supporting structure is configured to support the fuel cells in two spatial directions which run transversely with respect to the stack direction.

To this end, for example, the supporting structure can run on all four side surfaces of the arrangement of a plurality of fuel cells, and can therefore introduce a prestress on each of the side surfaces. The supporting structure can also, however, have a second contact portion which is formed, in a manner which matches a first contact portion, on the components of the fuel cells (such as, for example, their bipolar plates), with the result that the supporting structure on one of the side surfaces of the arrangement of a plurality of fuel cells additionally introduces a prestress parallel to the corresponding side surface and perpendicularly with respect to the stack direction. As a result, a supporting structure which is present merely on one side surface of the arrangement can also already make a supporting action in both directions perpendicularly with respect to the stack direction possible.

In accordance with a further embodiment, the supporting structure is arranged on the end plates or can be fastened to a base which supports the fuel cell stack.

In accordance with a further embodiment, the supporting structure has at least one resilient element which pushes on at least one side surface of the arrangement of a plurality of fuel cells transversely with respect to the stack direction.

Furthermore, as an alternative or in addition, one plate (or a plurality thereof) which is functionally passive with regard to the actual function of the fuel cell stack (and is also called a “middle plate” herein) can also be provided at any position along the stack direction. A middle plate of this type divides the arrangement into a plurality of part stacks which have a smaller part stack height in the stack direction than the entire arrangement of a plurality of fuel cells. The middle plate then serves as a single or additional contact partner with the supporting structure. Since the part stack height of the part stacks is smaller than the stack height of the entire stack, a deformation of the stack is prevented or at least reduced.

A resilient element of this type can be, for example, an elastic clip-like element which has a bent starting position. The resilient element can be manufactured, for example, from a metallic material or else a plastic material which has a certain flexibility, with the result that the resilient element pushes back into the starting position when it is bent out of the starting position. In particular, a resilient element made from plastic can contribute to the electrical insulation of the individual fuel cells, as described herein further below. When the resilient element is bent straight from the bent starting position, it pushes back into the bent starting position and thus makes a tensioning force available. If the bent-straight resilient element is then fastened, for example, to the end plates of the fuel cell stack or to a surrounding structure at the ends and is then released, the spring element pushes into the starting position (since its ends are fixed on the end plates) and in the process presses on the side surface of the arrangement of a plurality of fuel cells, as described further above. In particular, the resilient element can be the above-described preshaped element.

In accordance with a further embodiment, the supporting structure has at least one arrangement comprising a rigid holder and a compressible component. The compressible component is arranged between the relevant side surface of the arrangement of a plurality of fuel cells and the rigid holder.

The compressible component is arranged between the preshaped element and the corresponding side surface of the arrangement of a plurality of fuel cells. Here, the compressible component is pressed onto the respective side surface by way of the preshaped element or by way of corresponding intermediate layers which lie between the preshaped element and the side surface (such as, for example, electrically insulating components and sliding elements, if present) and preferably has deformable surfaces. The compressible component can therefore be adapted to the shape/contour both of the side surface of the arrangement and to the shape/contour of the elements of the supporting structure which lie further to the outside. As a result, damage of the fuel cells by way of a not completely homogeneous surface is avoided (that is to say, minor positioning errors of the individual fuel cells with respect to one another are compensated for), and the prestress is introduced homogeneously into the arrangement of a plurality of fuel cells. The compressible component can be manufactured from any suitable material and has a high friction with regard to the side surfaces. The compressible component is, for example, an elastic element or a foam. The compressible component also generally protects softer elements of the supporting structure against damage on account of sharp edges of the fuel cell elements.

In accordance with a further embodiment, the compressible component comprises a fluid-filled cushion or a foam.

In accordance with a further embodiment, the supporting structure consists of an electrically insulating material or is coated with an electrically insulating material, or at least one electrically insulating component is positioned between the supporting structure and the arrangement of a plurality of fuel cells.

The supporting structure or parts thereof can be manufactured from electrically insulating materials. In particular, elements of the supporting structure which come into direct contact with the arrangement of a plurality of fuel cells are manufactured from electrically insulating materials or are coated with materials of this type. Electrically insulating materials can be, for example, different plastics, resins, foam materials or similar materials.

In accordance with a further embodiment, the electrically insulating component is configured as a sliding element, in order to permit sliding between the arrangement of a plurality of fuel cells and the supporting structure.

A sliding plane of this type, the arrangement of which has already been described further above, makes it possible, in particular, that elements of the supporting structure which lie between the prefabricated element and the arrangement of a plurality of fuel cells can slide on one another or can be generally displaced with respect to one another in the stack direction. As a result, longitudinal loads along the stack direction on the individual fuel cells are avoided, since the prefabricated element and the remaining elements of the supporting structure can be oriented along the stack direction relative to one another in such a way that no forces of this type act.

In accordance with a further embodiment, the supporting structure is in full surface contact with the arrangement of a plurality of fuel cells.

In particular, the preshaped element of the supporting structure itself can push against the arrangement, for example if the preshaped element is a resilient element, as described further above. The preshaped element can also, however, hold other elements of the supporting structure such as, for example, the electrically insulating component described further above, the compression apparatus, or the compressible component, between the preshaped element and the corresponding side surface of the arrangement of a plurality of fuel cells in such a way that these enclosed elements push against the side surface and accordingly introduce the prestress. The last-mentioned alternative comes into consideration, for example, if the preshaped element is a rigid element. The supporting structure can also, however, be in full surface contact with the arrangement of a plurality of fuel cells by way of a combination of these alternatives. To this end, the preshaped element can be in direct full surface contact with the arrangement of a plurality of fuel cells at some locations, and can be in full surface contact with the arrangement in other regions via further elements which lie in between. In addition, it is also conceivable that the supporting structure is in full surface contact with the arrangement of a plurality of fuel cells only at some locations (in particular, at particularly loaded locations).

In accordance with a further embodiment, the arrangement of a plurality of fuel cells has a plurality of cell components. The cell components each have a peripheral edge which has at least one first contact portion which is shaped so as to correspond with a second contact portion of the supporting structure, with the result that the first contact portion and the second contact portion can be brought flushly into full surface contact.

The cell components can be, for example, bipolar plates, seals, or other cell components. In embodiments with a middle plate, for example, a middle plate of this type can also be configured correspondingly. It is to be noted here, however, that the middle plate is not a cell component, but rather a separate mechanical element in the cell stack which is stacked in addition to the cell components.

The fact that the first contact portion and the second contact portion are shaped in a corresponding manner means here, in particular, that, as viewed in a cross section, the first contact portion has a negative shape of the second contact portion, with the result that the first contact portion and the second contact portion fit into one another in such a way that the supporting structure prevents a lateral displacement of the bipolar plates. Furthermore, as described above, electrically insulating components, sliding elements, compression apparatuses, and other intermediate layers can also be provided here, in order to achieve the effects described further above with regard to these elements.

Furthermore, the second contact portion can be configured in one part or in two parts. In the case of a two-part configuration, the course of the supporting structure is therefore at least partially in two parts. In contrast, a one-part configuration makes smaller thicknesses of the supporting structure and a higher flexural rigidity possible.

In accordance with a further embodiment, the first contact portion and the second contact portion are chamfered.

A chamfer means here, in particular, that the surfaces of the contact portions do not run parallel to the general lateral extent of the bipolar plates (that is to say, with respect to the direction of extent of the bipolar plates which together define the side surface of the arrangement of a plurality of fuel cells), but rather are at at least an angle which is not equal to 0° with respect to this direction. For example, the first contact portion can form a wedge in relation to the direction of the lateral extent. The second contact portion can define a corresponding recess in the supporting structure, into which recess the first contact portion fits. As a result of the wedge effect achieved in this way, a lateral displacement both perpendicularly with respect to the side surface, on which the supporting structure runs, and also parallel with respect thereto is effectively prevented.

In accordance with a further embodiment, the supporting structure has a compression apparatus for the fuel cell stack and exerts a pressing force, running in the stack direction, on the arrangement of a plurality of fuel cells.

The compression apparatus can be, for example, a strap or another suitable apparatus. A strap of this type can be tensioned, for example, substantially along the stack direction. If, in particular, a strap of this type is manufactured from a flexurally slack material, a sufficient prestress can be achieved, for example, by way of a compressible component, as described further above, which lies in between and is pressed onto the side surface by way of the strap.

In accordance with a further embodiment, an elastic intermediate layer for improving towards a homogeneous full surface fit and therefore for balancing (homogeneously distributing) a pressure force which is exerted by the supporting structure on the arrangement of a plurality of fuel cells is arranged between the supporting structure and the arrangement of a plurality of fuel cells.

An elastic intermediate layer of this type can be adapted to deviations of the corresponding side surface from the perfectly planar shape, and can thus, inter alia, compensate for inaccuracies when the individual fuel cells are stacked on one another. As a result, the variation of the pressure force/pressing force as a result of inaccuracies of this type can be compensated for.

In accordance with a further embodiment, the fuel cell stack has, furthermore, a slidable intermediate layer which can be adhesively bonded to the elastic intermediate layer and is configured to slide on the supporting structure.

Since the slidable intermediate layer can be adhesively bonded to the elastic intermediate layer, it cannot be displaced relative to the elastic intermediate layer along the stack direction. As a result of the sliding capability with regard to the supporting structure (or with regard to the preshaped element of the supporting structure), however, a sliding plane parallel to the corresponding side surface with respect to the preshaped element is formed. As a result, in particular, longitudinal expansions or fluctuations along the stack direction which occur, for example, as a result of temperature and/or pressure differences in the interior of the stack, but also relative movements in the stack direction during vibrating of the stack, can be compensated for. In addition, the elastic intermediate layer makes a lateral compensation of assembly inaccuracies possible, as described above.

In accordance with a second aspect, a method is provided for mounting a lateral supporting structure on a fuel cell stack which comprises an arrangement of a plurality of fuel cells which are stacked in a stack direction, and two end plates which delimit the arrangement and are arranged opposite one another in the stack direction. The supporting structure comprises at least one elastic preshaped element. The method comprises the following steps: attaching in each case one mounting frame to each of the preshaped elements. Tensioning each of the preshaped elements out of a rest position into a tensioned position. Fastening the at least one preshaped element on opposite sides of the fuel cell stack. Furthermore, the method comprises releasing the mounting frame, with the result that the at least one preshaped element pushes back into its rest position and in the process exerts a lateral tensioning force on the arrangement of a plurality of fuel cells. The lateral tensioning force laterally supports the arrangement of a plurality of fuel cells.

The preshaped element is preferably a resilient element such as, for example, a clip-like element, which has a rest position or bent starting position (that is to say, in a state without an external action of force, the element is in its bent shape). If the prefabricated element is moved out of this rest position by way of bending, it exerts a restoring force which pushes the prefabricated element back into the rest position. The preshaped element is set into a tensioned position by way of corresponding deforming or bending before being mounted. This tensioning can take place, for example, in a pressing apparatus or, as described below, by way of a pulling tool or in a different way after the connection to the mounting frame.

The mounting frame is fastened to the preshaped element (in particular, on the side which faces away from the fuel cell stack in the installed state, that is to say on a concave region of the preshaped element). Here, the mounting frame holds the preshaped element at the ends in the stack direction. In addition, the mounting frame firmly holds the preshaped element on at least one region between the ends (inner region). Each of these regions can be held, for example, by way of an arm of the mounting frame.

In addition, a pulling tool of the mounting frame can optionally (as described above) be situated on the inner region, or on the corresponding holding arm. The pulling tool can be, for example, a spindle or another linear actuator which makes it possible for the inner region to be pulled outwards in the direction of the mounting frame. Since the preshaped element is held at the ends in the mounting frame, the preshaped element is pulled straight by way of the pulling on the inner region by way of the pulling tool, as a result of which a restoring force is produced by way of the preshaped element. It should be noted, however, that a pulling tool of this type is merely one possibility for tensioning the preshaped element. In particular, the preshaped element can also be tensioned before the connection to the mounting tool, for example in a corresponding press, and can only then be connected to the mounting frame.

Subsequently, the remaining components of the supporting structure can optionally, as described further above in relation to the fuel cell stack, be fastened to the preshaped element. For example, different electrically insulating components, sliding elements, compression apparatuses, compressible components, etc., as described herein, can be attached to the supporting structure. Here, elements of this type can either be provided continuously along the stack direction or merely at certain locations, in particular on regions which are particularly loaded during operation, that is to say are particularly prone to a deflection of the fuel cell stack.

After the supporting structure has been completely premounted, it is guided with the mounting frame onto the fuel cell stack, and the ends of the supporting structure or of the preshaped elements are fastened, that is to say the at least one preshaped element is guided onto and fastened to opposite side surfaces of the arrangement of a plurality of fuel cells. If merely one preshaped element is used, it goes without saying that this is fastened merely to one side surface of the arrangement. If, for example, two preshaped elements are used, they are fastened to two opposite side surfaces, etc. Here, for example, the ends can be fastened to the end plates of the fuel cell stack or to a surrounding structure which is connected to the fuel cell stack (for example, a base plate), by way of any suitable fastening type (such as, for example, welding, riveting, screwing, adhesive bonding).

After the preshaped elements have been guided onto and fastened to the opposite sides of the fuel cell stack, the corresponding mounting frames are released synchronously or step-by-step. To this end, for example, the corresponding pulling tools are either released/opened at the same time or so as to follow one another step-by-step, or the mounting frames themselves are removed step-by-step. As a result of synchronous releasing of the pulling tools of this type, a displacement of the arrangement of a plurality of fuel cells is avoided, since the restoring forces as a result of the elastic preshaped elements which lie opposite one another and push back into the rest position are compensated for at least approximately at every time and therefore lead to a resulting lateral zero force on the arrangement. When the preshaped elements move back into the rest position, they press on the corresponding side surfaces and support the fuel cell stack on account of the fastening at the ends to the fuel cell stack (or a surrounding structure).

The mounting frames are then released completely from the prefabricated elements.

In summary, the invention therefore provides a fuel cell stack which has a lateral supporting structure. The supporting structure prevents lateral slipping of individual fuel cells in the fuel cell stack or the deflection/deformation of the stack which can occur, in particular, in highly dynamic environments, such as aircraft, on account of the different actions of force and vibrations. It should be recognized, however, that the fuel cell stack can advantageously also be used in different environments such as, for example, motor vehicles, trains, etc. The supporting structure reliably prevents an impermissible deformation or damage of the fuel cell stack in high load environments of this type.

### BRIEF DESCRIPTION OF THE DRAWINGS

In the following text, exemplary embodiments will be described in greater detail on the basis of the appended drawings. The illustrations are diagrammatic and not true to scale. Identical reference signs relate to identical or similar elements. In the drawings:

FIG. 1 shows a diagrammatic illustration of a fuel cell stack according to the prior art.

FIG. 2 shows a diagrammatic illustration of a possible deflection in the case of a fuel cell arrangement without a supporting structure.

FIG. 3 shows a highly diagrammatic illustration of a fuel cell stack with a supporting structure, and the effect of the supporting structure in the case of the occurrence of a deflection.

FIG. 4 shows a diagrammatic illustration of a cross section through a fuel cell stack with an exemplary supporting structure.

FIG. 5 shows a diagrammatic illustration of a part element of a fuel cell and its contact with the supporting structure.

FIG. 6 shows a diagrammatic side view of a fuel cell stack with an exemplary supporting structure, and a cross-sectional view through the fuel cell stack in a plan view which illustrates the contact of the supporting structure with a part element of the fuel cell stack.

FIG. 7 shows a diagrammatic side view of a fuel cell stack with a further exemplary supporting structure, and a cross-sectional view through the fuel cell stack in a plan view which illustrates the contact of the supporting structure with a part element of the fuel cell stack.

FIG. 8 shows two diagrammatic side views from perspectives which are perpendicular with respect to one another of a fuel cell stack with a supporting structure with a resilient element.

FIG. 9 shows diagrammatic illustrations of the resilient element from FIG. 8 in three states.

FIG. 10 shows a diagrammatic flow chart of a method for mounting a supporting structure with a resilient element on a fuel cell stack by means of a mounting frame.

FIG. 11 shows a diagrammatic side view of a fuel cell stack with a supporting structure with a compressible component which is connected to a rigid holder or a resilient element in a manner which slides in the perpendicular direction.

FIG. 12 shows a diagrammatic view of the layer structure of the supporting structure from FIG. 11.

FIG. 13 shows a diagrammatic side view of a fuel cell stack with a supporting structure with a protective layer or with a sacrificial material, which supporting structure is connected to a rigid holder or a resilient element in a manner which slides in the perpendicular direction.

FIG. 14 shows a diagrammatic view of the layer structure of the supporting structure from FIG. 11.

### DETAILED DESCRIPTION OF EMBODIMENTS

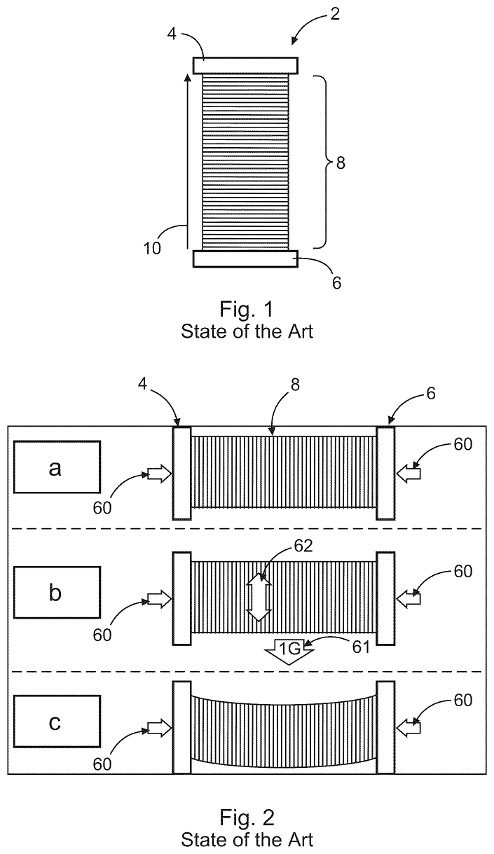

FIG. 1 shows a fuel cell stack 2 from the prior art, without a supporting structure. The fuel cell stack 2 comprises a first end plate 4 and a second end plate 6. An arrangement 8 of a plurality of fuel cells are stacked on one another in a stack direction 10 between the first end plate 4 and the second end plate 6, and this is held together by the first end plate 4 and the second plate 6, for example by way of a compression force which is exerted by way of the end plates 4, 6 and acts in the stack direction 10. The fuel cell stack 2 is arranged perpendicularly in FIG. 1, that is to say the fuel cells of the arrangement 8 are stacked in the perpendicular direction (from the bottom to the top).

FIG. 2 illustrates the problem in the case of a fuel cell stack 2 according to FIG. 1 (or a similar fuel cell stack from the prior art), from which the present invention proceeds. The fuel cell stack 2 is arranged horizontally here, with the result that the surface planes of the individual fuel cells of the arrangement 8 run perpendicularly, and the gravity vector 61 acts in or along the respective surface planes. The fuel cells in the arrangement 8 are pressed together by way of the end plates 4, 6 by a clamping force 60 which acts along the stack direction 10 (FIG. 1).

Here, the upper part of FIG. 2 shows the fuel cell stack in a first state a which corresponds to the state before the start of operation. Here, the fuel cells of the arrangement still lie next to one another as intended correctly and without a relative lateral displacement.

The state b illustrates the fuel cell stack 2 immediately after start of operation. As a result of the operation, for example in an aircraft, vibrations 62 are caused within the arrangement 8 of fuel cells. At the same time, the gravity vector 61 acts perpendicularly with respect to the stack direction 10 of the arrangement 8. Instead of or in addition to the force of gravity, however, other forces can also act such as, for example, centrifugal forces during the flight of an aircraft.

As a result of the vibrations 62 and the force 61, the arrangement 8 of fuel cells deflects over time in the direction of the force 61, by the individual fuel cells of the arrangement 8 being displaced relative to one another perpendicularly with respect to the stack direction 10. This is shown in state c which indicates the state some time after start of operation. As can be easily seen, a deflection of this type can lead to damage of the fuel cell stack 2.

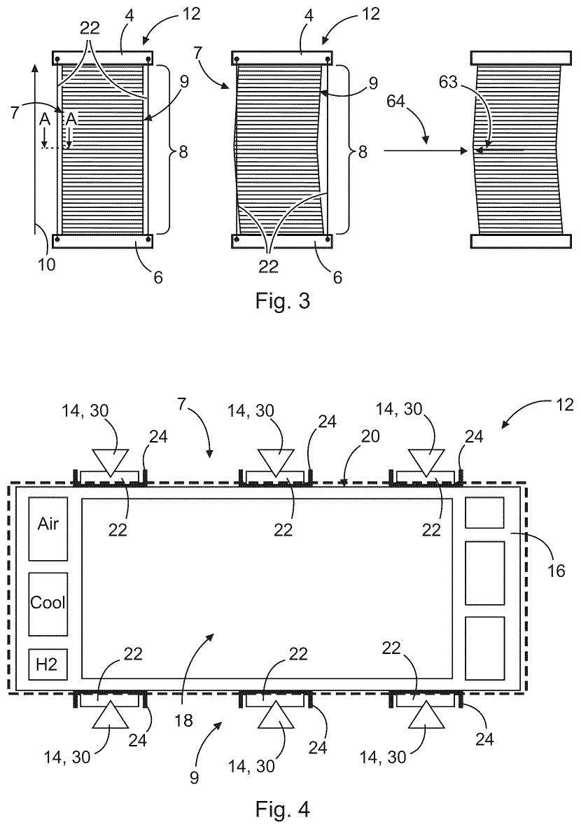

FIG. 3 highly diagrammatically shows a fuel cell stack 12 which is enhanced with a supporting structure 14 in comparison with the fuel cell stack 2 from FIG. 1. The supporting structure itself is not shown in FIG. 3, but can be fastened to the end plates 4, 6 of the fuel cell stack 12 and can run along the stack direction 10 (see FIG. 1) of the arrangement 8 of fuel cells. Here, the supporting structure 14 runs on two side surfaces 7, 9 of the fuel cell stack 12. Although the supporting structure can be fastened to the end plates 4, 6 and can run between the latter, it should be recognized that the supporting structure can also be fastened differently. For example, the supporting structure can also be fastened to a structure which supports the fuel cell stack 12. In addition, FIG. 3 diagrammatically illustrates the effect of a supporting structure 14 of this type (FIGS. 4 to 14) which can be configured in accordance with any one of the embodiments described further below in relation to FIGS. 4 to 14.

Here, the left-hand side of FIG. 3 illustrates the fuel cell stack 12 with the tie rods 22 which are customary in the prior art, before slipping of the fuel cells in the arrangement 8 has started. Here, the individual fuel cells are still stacked on one another correctly and without a relative lateral displacement.

The middle part of FIG. 3 shows the fuel cell stack 12 after lateral slipping of precisely this type transversely with respect to the stack direction 10 has begun. The fuel cells of the arrangement 8, or the side surface 7 of the arrangement 8, which have been displaced laterally (to the left here) move in the direction of the tie rods 22, which can impermissibly reduce the spacing from the tie rods 22.

The right-hand side of FIG. 3 illustrates the force of action of the supporting structure 14 (not shown) and the arrangement 8 of a plurality of fuel cells, the supporting structure 14 not being shown for improved visibility of the action of force. If the individual fuel cells press against the supporting structure with a certain shifting force 63, the supporting structure generates a counterforce 64 which counteracts the displacement of the fuel cells in the direction of the tie rods 22. As soon as the forces 63 and 64 are in equilibrium, no further displacement of the fuel cells transversely with respect to the stack direction 10 can take place.

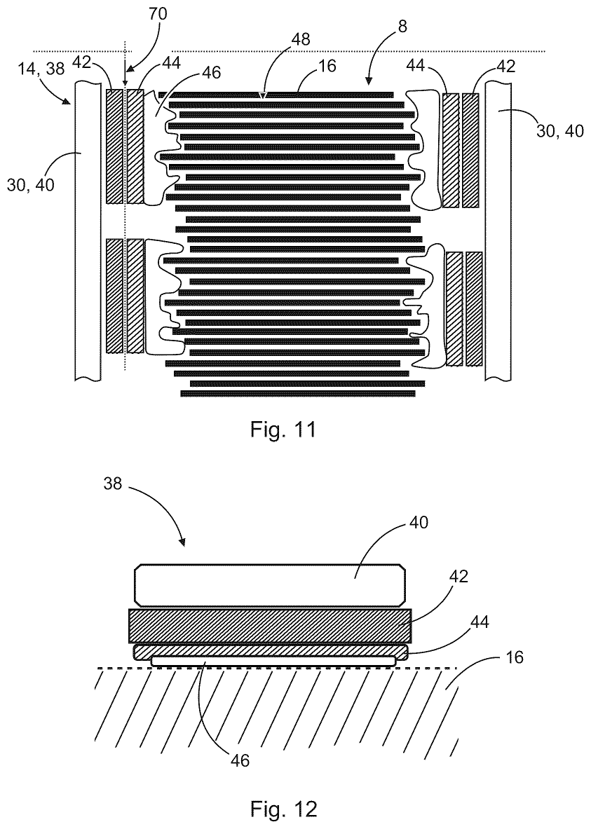

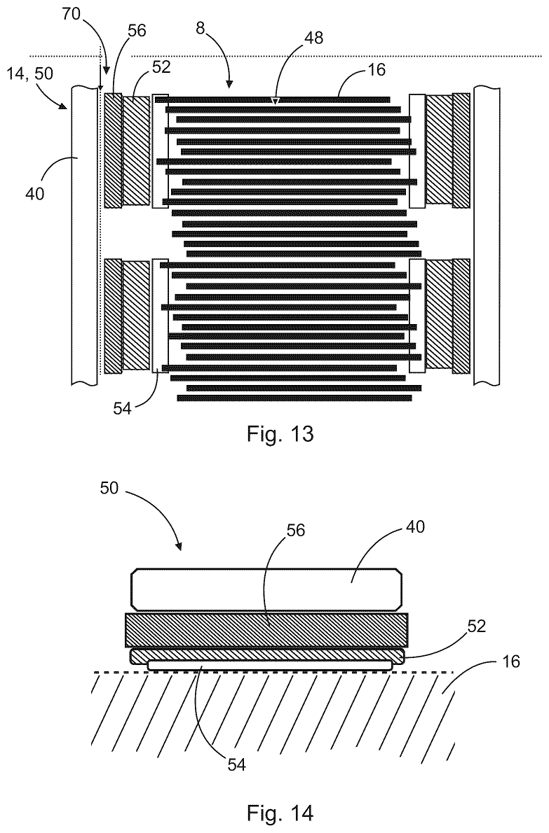

FIG. 4 shows a cross section through an exemplary fuel cell stack 12 with a supporting structure 14 which is divided into six part structures (three on each side). Here, the cross section shows a sectional plane perpendicularly with respect to the stack direction 10 in FIG. 1. The view is a plan view of, for example, one of the bipolar plates 16 of the fuel cell stack 12 which is situated in the fuel cell stack 12. Here, three part structures of the supporting structure 14 are provided on each of the side surfaces 7 and 9, as a result of which slipping of individual fuel cells or of elements of individual fuel cells out of the stack in the direction of the two side surfaces 7, 9 is avoided. In addition, a compression apparatus 22 (these are typically tie rods which can be configured as a screw, strap or the like) which is realized here in the form of a strap 22 which runs along the stack direction 10, and an electrically insulating component 24 which can optionally be configured as a sliding element 24 are arranged between each part of the supporting structure 14 and the fuel cell stack 12. The supporting structure 14 itself is manufactured from a mechanically strong and substantially rigid material such as, for example, a metal. Here, the supporting structure comprises both flexurally rigid elements and the prestressed resilient elements described herein. It goes without saying that a resilient element of this type is not flexurally rigid, since it applies the prestress for the fuel cell stack precisely as a result of the introduced flexural stress. In the case of the embodiments of FIGS. 11 and 13, however, the elements 30 and 40 can be flexurally rigid elements.

In order to avoid short-circuits in the fuel cell stack 12 which might occur, for example, if two or more cells were connected electrically to one another by way of the compression apparatus 22, the electrically insulating component 24 is provided between the compression apparatus 22 and the arrangement 8 of a plurality of fuel cells. This component which is required in any case can be configured in such a form that, in addition to the main requirement, namely the insulation of the compression apparatus, it also acts as a sliding element, with the result that the requirements for the application of a supporting structure can also be covered. As a result, direct contact of the supporting structure 14 or the electrically conductive components of the supporting structure 14 with the components of the fuel cells (for example, the bipolar plates) is avoided. The compression apparatus can be, for example, a peripheral strap which encloses the fuel cell stack. The supporting structure 14 presses the compression apparatus 22 on the side surfaces 7, 9 against the arrangement 8 comprising a plurality of fuel cells. The supporting structure 14 can, for example, comprise generally preshaped elements 30, 40 which can be configured, for example, (as shown in FIGS. 6 to 10) as resilient elements 30, or else as flexurally rigid elements (as in FIGS. 11 to 14). It is to be noted, however, that the elements 30, 40 in the FIGS. 11 to 14 can likewise be resilient elements. These preshaped and/or resilient elements 30 laterally clamp in the fuel cell stack 12, as described further above, as a result of which a lateral supporting action is achieved.

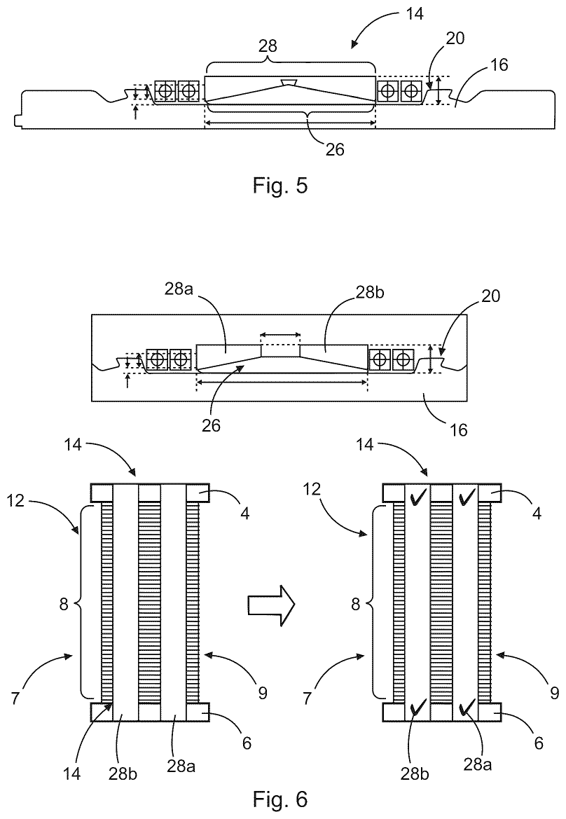

FIGS. 5 and 6 show a fuel cell stack 12 with a supporting structure 14, the supporting structure 14 being in full surface contact with the arrangement 8 of a plurality of fuel cells. FIGS. 5 and 6 are described together in the following text. FIG. 5 and the upper region of FIG. 6 show a cell component 16 (or a side of a bipolar plate 16) in the fuel cell stack 12 in a plan view. That is to say, FIG. 5 and the upper part of FIG. 6 show a section through the fuel cell stack 12, shown in the lower part of FIG. 6, into the plane of the drawing.

It should be noted that, although FIGS. 5 and 6 show a chamfered contact surface between the supporting structure and the cell components 16, an engagement of the supporting structure can also take place without a chamfered contact surface of this type or generally without a feature explicitly formed on the cell components 16. For example, the supporting structure can also be in a straight full surface contact with the cell components 16. It is also conceivable, however, that the engagement regions have to be of specific design, with the result that the absorption of force by individual cell components 16 which can be partially deformed or can be damaged easily might require a specific design solution. This is not absolutely necessary, however, for the subject matter of the present disclosure and is not to be interpreted as restrictive.

The cell component 16 in FIGS. 5 and 6 has a first contact portion 26 which is shaped so as to correspond to a second contact portion 28 of the supporting structure 14. In other words, the cell component 16 has a projection or a wedge (first contact portion 26) which is shaped in such a way that it fits into a corresponding recess of the second contact portion 28, with the result that the first contact portion 26 and the second contact portion 28 can be brought flushly into full surface contact.

In addition, in the configuration which is shown, both the first contact portion 26 and the second contact portion 28 are chamfered. It should be recognized, however, that the first contact portion 26 and the second contact portion 28 can also be configured so as to correspond to one another in another way such as, for example, with correspondingly configured grooves and projections, and this does not exclusively have to take place via a chamfer as shown. As a result of the chamfer, the supporting structure 14 supports the fuel cell stack 12 in both directions perpendicularly with respect to the stack direction 10. In FIGS. 5 and 6, the second contact portion 28 is split in two with a first segment 28a and a second segment 28b of the second contact portion. The use of a second contact portion 28 which is split in two improves the compensation of CRA (Cell Row Assembly) tolerances. In particular, the use of a single contiguous element instead of two elements increases the flexural rigidity and therefore the geometrical moment of inertia on account of the connection of the two elements by way of additional material. This can also prove disadvantageous, however, for the compensation of stack tolerances in the case of oblique positioning or offset of the end plates or the stack. Here, oblique positioning can possibly be compensated for more easily by way of two individual elements than by way of one element. Accordingly, a corresponding design can be selected according to requirements and these factors.

Although described here in relation to a cell component 16, it should be recognized that other elements of the fuel cells such as, for example, sealing elements or other cell components can likewise also be equipped with corresponding first contact portions 26.

The second contact portion 28 can be, for example, a preshaped element 30 in the form of a resilient element 30, as described further below in relation to FIGS. 8 to 10. In addition, further elements or layers such as, for example, the sliding elements described herein, electrically insulating components, etc. can be arranged between the first contact portion 26 and the second contact portion. For example, the layer structure at the contact surfaces between the first contact portion 26 and the second contact portion 28 can correspond to the structure shown in FIGS. 11 and 12 or in FIGS. 13 and 14. It is also conceivable, however, that the second contact portion 28 itself is formed, for example, from an electrically insulating material with sufficient rigidity.

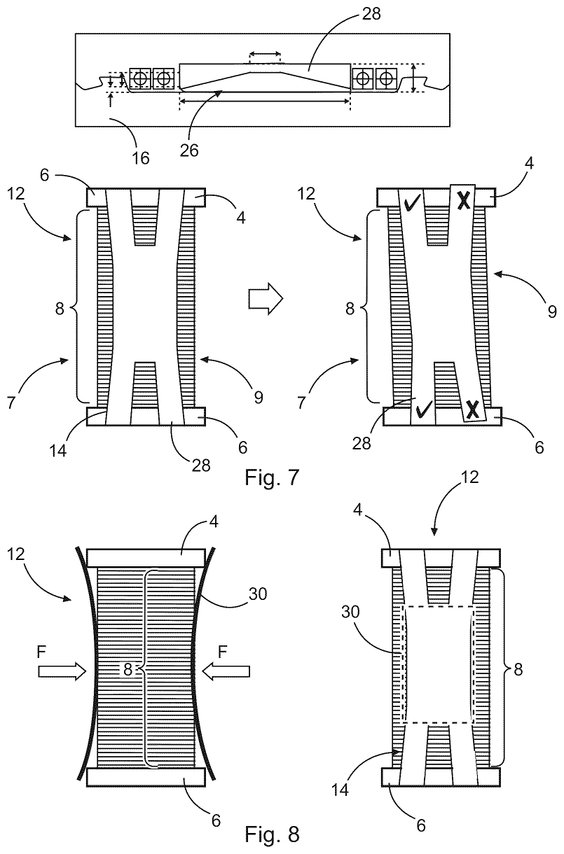

FIG. 7 shows a further configuration of a fuel cell stack 12 which differs from the configuration from FIGS. 5 and 6 in that the second contact portion 28 is configured in one piece in the manner of a “braces shape”. As a result of this configuration, the thickness extent of the second contact portion 28 can be reduced, since a single-piece construction increases the mechanical stability of the supporting structure 14 overall. Both the single-piece and the two-piece construction of the second contact portion 28 fulfil the intended supporting action, however. The comparison of the mechanical stability of the single-piece construction with the two-piece construction can be seen diagrammatically on the right-hand sides of FIGS. 6 and 7. It should be recognized that the continuous contact portion can optionally also be present along the entire stack direction 10, and not only, as shown, in a central region.

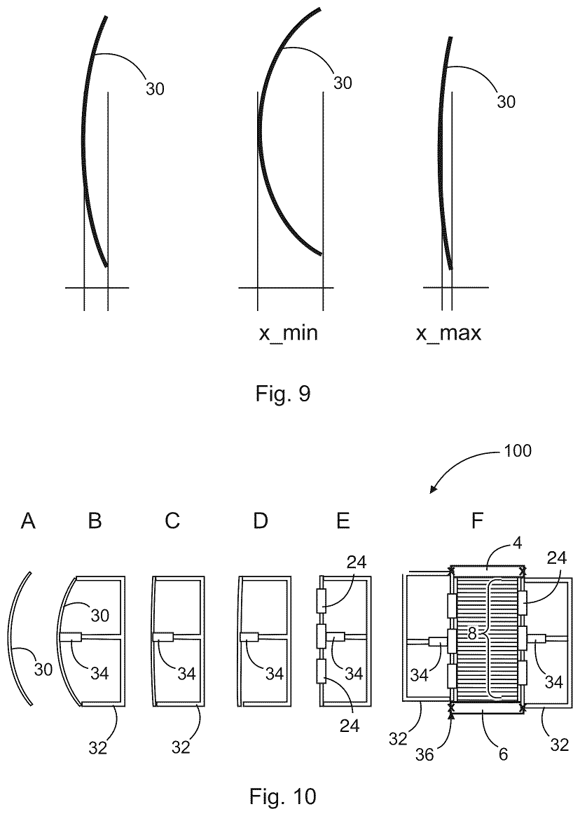

FIGS. 8 and 9 show a preshaped element 30 which is configured as a resilient element 30. The preshaped element 30 is therefore manufactured from an elastic/resilient material such as, for example, a metal. FIG. 8 shows the preshaped element 30 in an installed state in the fuel cell stack 12. FIG. 9 shows the preshaped element 30 in three different bending states.

One or more preshaped elements 30 of this type can be used as second contact portions 28, for example, in the case of the supporting structures shown in FIGS. 5 to 7. Furthermore, preshaped elements 30 of this type can also be used in the case of the supporting structure 14 in FIG. 4 (triangles in FIG. 4). FIG. 8 shows two preshaped/resilient elements 30 in a side view of the fuel cell stack 12 (left-hand side) and in a front view of the fuel cell stack (right-hand side) in an installed state. It should also be recognized here that there can also be further functional intermediate layers such as, for example, described below in relation to FIGS. 10 to 14 between the preshaped components 30 and the arrangement 8 of a plurality of fuel cells.

The preshaped elements 30 are fastened to the end plates 4, 6 in the configuration which is shown, and are arranged on opposite side surfaces 7, 9 of the fuel cell stack 12. Accordingly, the preshaped elements 30 exert a two-sided supporting action (force arrows F) on the arrangement 8, since the preshaped elements 30 are bent in the installed state into a position which differs from the respective rest position. It can be seen on the right-hand side of FIG. 8 that the preshaped elements 30 can serve, for example, as second contact portions 28 of the supporting structure 14, as described in relation to FIG. 7.

In order to illustrate the effect of preshaped elements 30 of this type, FIG. 9 shows a preshaped element 30 of this type in three different bending states. The middle depiction of FIG. 9 shows the preshaped element 30 in its rest position (starting position, without the effect of an external force). On the left-hand side and the right-hand side of FIG. 9, the preshaped/resilient element 30 is deflected/bent straight out of the rest position to different degrees. In these bending states, the preshaped element pushes back into the rest position which is shown in the middle. If the preshaped element 30 is installed into and connected to the fuel cell stack 12 in a deflected position, as shown in FIG. 8, the ends of the preshaped element are fixed. During the attempt to bend back into the rest position, the preshaped element therefore introduces a lateral prestress into the fuel cell stack 12, which prestress counteracts a deformation of the fuel cell stack 12 (such as, for example, a lateral displacement of the individual fuel cells relative to one another or any other deformation of the stack in its entirety), as described in detail further above.

FIG. 10 shows a sequence of steps of a method 100 for mounting a supporting structure 14 on a fuel cell stack. In step A, at least two preshaped elements 30 are provided (steps A to E each show only one preshaped element 30. A second element or a plurality of further elements can be prepared in parallel or following one another in an identical way before step F is carried out).

In step B, in each case one mounting frame 32 is fastened to the preshaped element 30. As shown, the mounting frame 32 can be fastened to the preshaped element 30, for example, by way of corresponding arms. In particular, the mounting frame 32 is fixed releasably on the preshaped element 30 at the outer ends (top and bottom in FIG. 10). At least one third arm can be fastened releasably to an inner region of the preshaped element 30. In the illustrated embodiment of the method, the third arm additionally has a pulling tool 34 which serves to pull the middle region in the direction of the mounting frame 34 and to introduce a prestress into the preshaped element 30 as a result. The pulling tool 34 can be any suitable tool such as, for example, a pulling spindle or any other suitable linear actuator. Furthermore, the pulling tool 34 can also be dispensed with completely. The deformation might then take place, for example, in a corresponding press before the preshaped element 30 is fastened to the mounting frame, and the fixing would then take place by way of the mounting frame. In embodiments of this type, however, a spindle might nevertheless be used for relieving or prestressing (position adjusting in the prestressed state). The prestressing mechanism would then therefore be realized with less travel and would therefore be implemented more simply.

The mounting frame 34 is attached to the concave side of the preshaped element 30, with the result that the pulling tool, when it is actuated, pulls the preshaped element 30 straight, as a result of which a stress is induced in the preshaped element 30, which stress leads to a restoring force.

In steps D and E, further components such as, for example, sliding elements (not shown), electrically insulating components 24 and other elements, as described herein, can then be attached step-by-step to the preshaped element 30. Elements of this type do not necessarily have to be mounted in the tensioned state, however. It is also conceivable that elements of this type are already attached in the non-tensioned state on the preshaped element 30. For example, segments which ensure the direct engagement with the stack surface can already be applied on the prestressed and preshaped element 30. Here, for example, one of the layer structures of FIGS. 11 and 12 or FIGS. 13 and 14 can be implemented.

After the preparation in steps D and E, the prepared supporting structures 14 (comprising the prefabricated elements 30 and the further elements 22, 24, etc.) can be attached to the fuel cell stack by way of fastening of the preshaped elements 30. For example, the preshaped elements can be connected at the ends to the end plates 4, 6.

Furthermore, in step G (not shown), the pulling tools 34 (or corresponding spindles or other tools if no pulling tool is used on the mounting frame) are released synchronously or in an alternating and step-by-step manner on the opposite sides of the supporting structure 14, and the mounting frames 34 are released from each of the preshaped elements 30. Since the supporting structure 14 or its preshaped elements 13 was/were fixed to the end plates 4, 6 in a position which is deflected out of the rest position, the restoring force presses, after the release of the mounting frames, against the arrangement 8 of a plurality of fuel cells and therefore laterally stabilizes the construction.

FIGS. 11 and 12 show a first layer structure of the supporting structure 14, 38. In the case of this structure, a rigid holder 40 runs parallel along the stack direction 10. Instead of a rigid holder 40, however, a preshaped/resilient element 30, as described above, can also be used. In other words, the layer structure which is described here can therefore also be implemented in the case of the supporting structures 14 described above in relation to the prefabricated element 30. It should be noted that the described structure can be present symmetrically on opposite side surfaces of the arrangement 8 of a plurality of fuel cells. An electrically insulating component 42 which can be manufactured, for example, from a plastic or another electrically non-conductive material is arranged directly adjacently with respect to the rigid holder 40 (or the prefabricated element 30). A further electrically insulating component 44 is arranged further to the inside adjacently with respect to the electrically insulating component 42. The electrically insulating component 42 has a high friction/adhesion, for example by way of adhesive bonding, with respect to the rigid holder 40 (or the preshaped element 30), and a low friction with respect to the electrically insulating component 44, which makes it possible for these components to slide on one another along a sliding plane 70. The components 40, 42 are therefore also called sliding elements 42, 44.

A compressible component 46 such as, for example, a fluid-filled cushion or a foam element is arranged between the sliding element 44 and the arrangement 8 of a plurality of fuel cells. As shown in FIG. 12, the compressible component 46 can also be integrated into the sliding element 44. The compressible component 46 has a high friction with respect to the arrangement 8 of a plurality of fuel cells, or with respect to their side surface, and is fixed to the sliding element 44. The compressible component therefore compensates for unevennesses or inaccuracies or cell positioning tolerances, while the sliding mechanism which is implemented by way of the sliding elements 42, 44 makes sliding along the sliding plane 70 possible, and thus also compensates, for example, for expansions/contractions of the fuel cell stack 14, 38 on account of temperature and/or pressure differences. In this way, damage of the fuel cell stack by way of the supporting structure 14, 38 can be avoided, while a lateral supporting action is achieved at the same time which prevents damage of the fuel cell stack on account of deflections. In addition, the compressible component 46 protects soft elements of the supporting structure 14, 38 such as, for example, the sliding elements 42, 44 against damage by way of sharp edges of the fuel cell components.

It should be noted, however, that this arrangement or embodiment of the individual components as elastic or rigid and as electrically insulating or non-insulating is merely by way of example. It is also conceivable, for example, to encapsulate the side surface, instead of the element 46, with a filling material, such as a resin, which provides a common (planar) surface for the individual cell components. In order to introduce the necessary prestress, one of the elements 42, 44 can then be compressible/elastic, for example. At least one of the elements 42, 44 then has to be rigid, however, with the result that a sliding plane is formed. Here, the sliding plane can be formed between the elements 40 and 42, between the elements 40 and 44 or between the elements 44 and 46. In general, a sliding plane is always formed between two rigid elements. In addition, electrical insulation always has to be achieved between the individual fuel cells. An electrically conductive connection/bridge between the individual fuel cells therefore has to be avoided. Any combination of elements 42, 44, 46 which meets these requirements is conceivable. In addition, individual layers can also be completely dispensed with, as long as it is ensured that at least one sliding plane is formed and the necessary prestress is introduced.

FIGS. 13 and 14 show a further possible layer structure of the supporting structure 14, 50. This layer structure can also be used in the case of the above-described supporting structure 14 with the preshaped element 30 or in the case of a supporting structure 50 with a rigid holder 40. Here, a sliding plane 70 is defined between the rigid holder 40 (or the preshaped element 30) and a slidable intermediate layer 56. The slidable intermediate layer can be manufactured, for example, from a plastic or another electrically insulating material, and makes sliding on the rigid holder 40 (or the preshaped element 30) on the sliding plane 70 possible. An elastic intermediate layer 52 makes a lateral compensation for inaccuracies possible, in a similar manner to in the case of the compressible component 46 from FIGS. 11 and 12. Furthermore, a protective layer 54 is provided in the case of the structure of FIGS. 13 and 14. The protective layer 54 can be, for example, a mechanically highly resistant material, in particular resistant to cuts. As a result, softer components of the layer structure are protected against damage by way of sharp edges. As an alternative, the protective layer 54 can also be, for example, a sacrificial material 54 which may be damaged by way of the fuel cells (that is to say, which may be cut into by way of the cell components to a certain extent, as a result of which a common contact surface is provided between the cell components and the supporting structure) and, as a result, prevents damage of the components which lie further to the outside. The protective layer 54 is additionally likewise electrically insulating, with the result that short-circuits are prevented. The supporting structure 14, 50 of FIGS. 13 and 14 is also arranged symmetrically on opposite side surfaces of the arrangement 8 of a plurality of fuel cells, as a result of which a lateral supporting effect is achieved. The elements 52, 54 in FIGS. 13 and 14 fulfil substantially the same task as the compressible component 46 of FIGS. 11 and 12.

Additionally, it is to be noted that “comprising” or “having” does not rule out any other elements or steps, and “a” or “one” does not rule out a multiplicity. Furthermore, it is to be noted that features or steps which have been described with reference to one of the above exemplary embodiments can also be used in combination with other features or steps of different above-described exemplary embodiments. Reference signs in the claims are not to be considered to be a restriction.

### LIST OF REFERENCE SIGNS

2 Fuel cell stack (prior art, without supporting structure)
4 First end plate
6 Second end plate
7 Side surface
8 Arrangement of a plurality of fuel cells
9 Side surface
10 Stack direction
12 Fuel cell stack
14 Supporting structure
16 Bipolar plate, cell components
18 Flow field
20 Edge
22 Compression apparatus (strap), tie rod
24 Electrically insulating component/sliding element
26 First contact portion
28 Second contact portion
28a, 28b Segments of the second contact portion
30 Resilient element/preshaped element
32 Mounting frame
34 Pulling tool
36 Connection
38 Supporting structure
40 Rigid holder
42 Electrically insulating component/sliding element
44 Electrically insulating component/sliding element
46 Compressible component
48 Membrane/electrode arrangement
50 Supporting structure
52 Elastic intermediate layer
54 Protective layer, sacrificial material
56 Slidable intermediate layer
58 Supporting structure
60 Clamping force
61 Gravity vector
62 Vibrations
63 Shifting force
64 Counterforce
70 Sliding plane
a State before start of operation
b State immediately after start of operation
c State after some time of operation
100 Method for mounting a supporting structure
A Provision of preshaped elements
B Attachment of mounting frames
C Tensioning of the mounting frames
D, E Attachment of additional elements of the supporting structure
F Fastening of prefabricated elements on fuel cell stack
G Synchronous release of the mounting frames

1. A fuel cell stack, comprising:
an arrangement of a plurality of fuel cells which are stacked in a stack direction;
two end plates which delimit the arrangement and are arranged opposite one another in the stack direction; and
a supporting structure which runs on at least one side surface of the arrangement and at least between the end plates,
the supporting structure being configured to support the fuel cells transversely with respect to the stack direction, in order to counteract a deformation of the arrangement of a plurality of fuel cells,
the supporting structure having an element which is preshaped such that, in a mounted state, the supporting structure exerts a prestress which acts on the arrangement of a plurality of fuel cells;
the prestress acting on the arrangement of a plurality of fuel cells transversely with respect to the stack direction.

2. The fuel cell stack according to claim 1,
the supporting structure running on at least one pair of two side surfaces of the fuel cell stack which are opposite one another.

3. The fuel cell stack according to claim 1,
the supporting structure being configured to support the fuel cells in two spatial directions which run transversely with respect to the stack direction.

4. The fuel cell stack according to claim 1,
the supporting structure being arranged on the end plates or being capable of being fastened to a base which supports the fuel cell stack.

5. The fuel cell stack according to claim 1,
the supporting structure having at least one resilient element which pushes on at least one side surface of the arrangement of a plurality of fuel cells transversely with respect to the stack direction.

6. The fuel cell stack according to claim 1,
the supporting structure having at least one arrangement comprising a rigid holder and a compressible component,
the compressible component being arranged between the relevant side surface of the arrangement of a plurality of fuel cells and the rigid holder.

7. The fuel cell stack according to claim 6,
the compressible component comprising a fluid-filled cushion or a foam.

8. The fuel cell stack according to claim 1,
the supporting structure consisting of an electrically insulating material or being coated with an electrically insulating material, or at least one electrically insulating component being positioned between the supporting structure and the arrangement of a plurality of fuel cells.

9. The fuel cell stack according to claim 8,
the electrically insulating component being configured as a sliding element, in order to permit sliding between the arrangement of a plurality of fuel cells and the supporting structure.

10. The fuel cell stack according to claim 1,
the supporting structure being in full surface contact with the arrangement of a plurality of fuel cells.

11. The fuel cell stack according to claim 10,
the arrangement of a plurality of fuel cells having a plurality of cell components, and
the cell components each having a peripheral edge which has at least one first contact portion which is shaped so as to correspond with a second contact portion of the supporting structure such that the first contact portion and the second contact portion can be brought flushly into full surface contact.

12. The fuel cell stack according to claim 11,
the first contact portion and the second contact portion being chamfered.

13. The fuel cell stack [[(12)]] according to claim 1,
the supporting structure having a compression apparatus for the fuel cell stack and exerting a pressing force, running in the stack direction, on the arrangement of a plurality of fuel cells.

14. The fuel cell stack according to claim 1, comprising;
an elastic intermediate layer for balancing a pressure force which is exerted by the supporting structure on the arrangement of a plurality of fuel cells being arranged between the supporting structure and the arrangement of a plurality of fuel cells.

15. The fuel cell stack according to claim 14,
having, furthermore, a slidable intermediate layer which can be adhesively bonded to the elastic intermediate layer and is configured to slide on the supporting structure.

16. A method for mounting a lateral supporting structure on a fuel cell stack, the fuel cell stack comprising:
an arrangement of a plurality of fuel cells which are stacked in a stack direction; and
two end plates which delimit the arrangement and are arranged opposite one another in the stack direction;
the supporting structure comprising at least one elastically preshaped element;
the method comprising:
attaching in each case one mounting frame to each of the at least one preshaped element;
tensioning each of the preshaped elements out of a rest position into a tensioned position;
fastening the at least one preshaped element on opposite sides to the end plates;
releasing the mounting frame, such that the at least one preshaped element pushes back into its rest position and exerts a lateral tensioning force on the arrangement of a plurality of fuel cells, which lateral tensioning force laterally supports the arrangement of a plurality of fuel cells.
